(19) United States
(12) Patent Application Publication
(10) Pub. No.: US 2026/0099400 A1
(43) Pub. Date: Apr. 9, 2026

(54) DATA-DRIVEN DETECTION OF ERRORS IN DATA PROCESSING FLOWS

(71) Applicant: Truist Bank, Charlotte, NC (US)

(72) Inventor: Matthew Laine Donlan, Charlotte, NC (US)

(73) Assignee: Truist Bank, Charlotte, NC (US)

(21) Appl. No.: 18/909,007

(22) Filed: Oct. 8, 2024

(51) Int. Cl. G06F 11/07

(52) U.S. Cl. CPC G06F 11/0793; G06F 11/0709

(57) ABSTRACT

An application executing on a processor may receive runtime data from a plurality of components of a system. The application may access a first processing template of a plurality of processing templates, the first processing template associated with a first processing operation performed by a subset of the plurality of components of the system. A model may determine, based on the runtime data and the first processing template, an error associated with a first component of the subset of the plurality of components of the system. The model may generate a corrective action based on the error. The application may initiate performance of the corrective action.

### BACKGROUND

Various entities may leverage numerous hardware and/or software components of computing systems for processing solutions. However, these systems are often disparate, as a given entity may develop some solutions internally while contracting with third parties who provide other solutions. As such, conventional solutions require significant time and resources to identify the cause of errors. More generally, conventional solutions lack the requisite information to identify the cause of errors.

### BRIEF SUMMARY

Embodiments of the present disclosure address the above needs and/or achieve other advantages by providing apparatuses and methods for data-driven detection of errors in data processing flows.

In various embodiments, a method can be implemented to control system performance by receiving runtime data from multiple components of a system. This method involves accessing processing templates related to specific operations performed by subsets of the system's components and determining errors based on these templates and received data. A model then generates corrective actions for identified errors, which are initiated by an application executing on a processor.

Similarly, instructions can be stored in non-transitory computer-readable storage media to guide a processor in receiving runtime data from system components, accessing processing templates associated with specific operations, determining system errors based on the received data and processing templates, generating corrective actions for these errors, and initiating performance of said corrective actions by an application.

An apparatus can also be designed to perform this method, comprising a processor that executes instructions stored in memory. These instructions direct the processor to receive runtime data from system components, access processing templates related to specific operations, determine errors based on received data and processing templates, generate corrective actions for these errors, and initiate performance of said corrective actions by an application.

The features, functions, and advantages that have been discussed may be achieved independently in various embodiments of the present disclosure or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates a system 100 in accordance with one embodiment.

FIG. 2A illustrates an aspect of the subject matter in accordance with one embodiment.

FIG. 2B illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 3C illustrates an aspect of the subject matter in accordance with one embodiment.

FIG. 4 illustrates a logic flow 400 in accordance with one embodiment.

FIG. 5 illustrates a logic flow 500 in accordance with one embodiment.

FIG. 6A is a diagram of a feedforward network, according to at least one embodiment, utilized in machine learning.

FIG. 6B is a diagram of a convolutional neural network, according to at least one embodiment, utilized in machine learning.

FIG. 6C is a diagram of a portion of the convolution neural network of FIG. 6B, according to at least one embodiment, illustrating assigned weights at connections or neurons.

FIG. 7 is a diagram representing an exemplary weighted sum computation in a node in an artificial neural network.

FIG. 8 is a diagram of a Recurrent Neural Network (RNN), according to at least one embodiment, utilized in machine learning.

FIG. 9 is a schematic logic diagram of an artificial intelligence program including a front-end and a back-end algorithm.

FIG. 10 is a flow chart representing a method, according to at least one embodiment, of model development and deployment by machine learning.

FIG. 11 illustrates a computing system 1100 for data-driven detection of errors in data processing flows, in accordance with one embodiment.

### DETAILED DESCRIPTION

Embodiments disclosed herein provide solutions for data-driven detection of errors in computing systems. Generally, embodiments disclosed herein may collect runtime data (also referred to as “exhaust data” or “telemetry data”) to facilitate the data-driven error detection. Runtime data may generally include data generated as systems operate. Examples of runtime data include, but are not limited to, output data, logs, metrics, events, exceptions, profiling data, configuration data, and/or traces. The runtime data may be generated by any system component, including hardware, software, or a combination of hardware and software.

In some embodiments, processing operations may be associated with one or more workflow templates. A workflow template may define a plurality of processing stages for a given processing operation. Embodiments disclosed herein may use the collected runtime data and the workflow templates to determine errors or other anomalous behavior in the system. In some embodiments, a model may be trained to detect errors based on the collected data and workflow templates. Once detected, an indication of an error may be generated and returned to one or more users. In some embodiments, one or more corrective actions may be generated and executed to correct the error. Embodiments are not limited in these contexts.

For example, a workflow template for a payment processing application may indicate that a payment is initiated on a user device, which generates data that hits a specific endpoint on a communications network. The workflow template may then indicate processing activity on the network endpoint, which causes the data to hit an application server that performs at least a portion of the processing for the payment processing application. The workflow template may then indicate processing activities in a payment processing network, followed database accesses, then processing in deposit systems, and so on.

In such an example, runtime data may be generated as each entity in the workflow template for the payment processing application operates. Embodiments disclosed herein may collect the generated runtime data and analyze the runtime data. For example, a model may process the runtime data and determine that the application server is not functioning correctly. In some embodiments, the model may generate a textual and/or graphical description of the error, e.g., that the application server is not functioning correctly. In some embodiments, the model may generate one or more corrective actions, e.g., to restore the application server to valid operating status. In some embodiments, the corrective actions are initiated to correct any identified errors. For example, the model may generate code to restart the application server. The code may be executed to restart the application server and correct the identified error. Embodiments are not limited in these contexts.

Advantageously, embodiments disclosed herein provide techniques to identify errors in using runtime data collected across a diverse set of hardware and/or software components of computing systems. By further detecting errors using workflow templates, embodiments disclosed herein are able to pinpoint the locations of errors in a processing flow that uses disparate resources of various computing systems. Doing so improves the performance of systems used to detect errors relative to conventional solutions, which required manual configuration and significant levels of integration across multiple diverse systems to detect errors. Furthermore, by pinpointing errors and identifying solutions to the errors, embodiments disclosed herein may repair or otherwise restore system components to functional operating states, thereby improving the performance of these systems. Embodiments are not limited in these contexts.

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the disclosure and enable one of ordinary skill in the art to make, use, and practice the disclosure.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

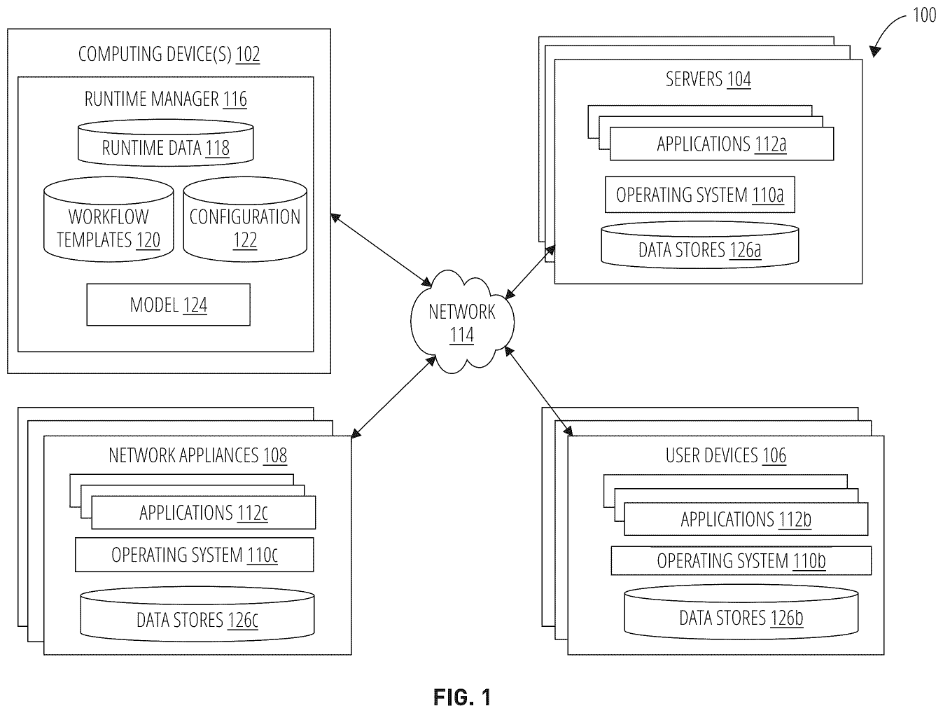

FIG. 1 illustrates a system 100 that provides data-driven detection of errors in data processing operations, according to one embodiment. As shown, the system 100 includes one or more computing devices 102, one or more servers 104, and one or more user devices 106 via one or more network appliances 108 of one or more networks 114. The computing device 102, servers 104, user devices 106, and/or network appliances 108 are representative of any type of physical and/or virtualized computing system.

As shown, the servers 104, user devices 106, and network appliances 108 execute operating systems 110a, 110b, and 110c, respectively. The operating systems 110a-110c may be any operating system, including but not limited to Linux® operating systems, UNIX®, Windows® operating systems, macOS®, iOS®, or Android®. The computing device 102 also includes an operating system, which is not pictured for clarity.

As shown, the servers 104 may store or otherwise host a plurality of applications 112a, the user devices 106 may store or otherwise execute a plurality of applications 112b, and the network appliances 108 may store or otherwise host a plurality of applications 112c. The applications 112a-112c are representative of any number and type of application. For example, the applications 112a-112c may include web browsers, account management applications, mobile P2P payment system client applications, applications provided by financial institutions, financial applications, payment applications, network functions, Automated Clearing House (ACH) applications, FedNow payment applications, real-time payments (RTP) applications, monetary transfer applications, mobile wallet applications, accounting applications, payment processing frameworks, etc. Although depicted as applications, the applications 112a-112c may are representative of any type of executable code, such as services, microservices, application programming interfaces (APIs), etc. Regardless of the type of a given application 112a-112c, in some embodiments, the applications 112a-112c may include features to process at least a portion of a transaction. The transactions may include purchases, payments, equity transactions, cryptocurrency sales, or any type of transaction. Furthermore, a given transaction may be processed at least in part by multiple applications 112a-112c.

The servers 104, user devices 106, and network appliances 108 may store or otherwise provide access to data stores 126a, 126b, and 126c, respectively. The data stores 126a-126c are representative of any number and type of data storage solutions, which may include databases, files, spreadsheets, storage media, and the like. Examples of data stores 126a-126c include, but are not limited to, account databases for customer accounts, databases for payment accounts, production databases for applications, financial institution databases, databases for cached data, and databases for files such as those for user accounts, user profiles, account balances, and transaction histories, files downloaded or received from other devices, and other data items and the like. Example accounts include a checking account, a savings account, a money market account, a certificate of deposit, a mortgage or other loan account, a retirement account, a brokerage account, or any other type of account.

The network appliances 108 are representative of any type of network appliance, such as routers, switches, servers, elements of switching fabrics, etc. Although depicted as external to the network 114, the network appliances 108 may be included in the network 114.

In some embodiments, some of the servers 104, user devices 106, and/or network appliances 108 may be part of a payment processing network (also referred to as “payment rails”). In such embodiments, the applications 112a-112c may include features to process payments, while some data stores 126a-126c may be used by the payment processing network. Although not depicted for the sake of clarity, the computing device 102 may also include other applications such as applications 112a-112c and/or data stores such as data stores 126a-126c. Embodiments are not limited in these contexts.

As shown, the computing device 102 includes a runtime manager 116. The runtime manager 116 is generally configured to provide data-driven detection of errors in computing systems such as the system 100 and any component thereof. The runtime manager 116 includes a data store of runtime data 118, a data store of workflow templates 120, a data store for configuration 122, and a model 124. The workflow templates 120 generally describes the processing phases of a plurality of processing operations. The processing operations may be any type of operation that can be performed using one or more computing devices, such as viewing account balances, sending funds to a recipient, sending and/or receiving messages, logging into a user account, etc. Because various components of the system 100 are used to process a given operation, the workflow templates 120 describe the flow of operations from one component to another.

For example, a payment processing operation processed at least in part by the system 100 may include 10 different servers, at least one user device, 6 different network appliances 108, and various segments of the network 114. As such, an entry for a payment processing operation in the workflow templates 120 may describe the sequence of processing by each component. For example, the entry may describe the order of operations, how each component of the system 100 contributes to the payment processing operation, and any other metadata attribute of the payment processing operation. Doing so may allow the runtime manager 116 and/or the model 124 to determine precise locations of errors in a given processing flow.

The runtime data 118 stores runtime data collected by the runtime manager 116 from different components of the system 100. Generally, computing systems in operation may generate significant amounts of data, whether it be output data (e.g., a file created by an application 112a-112c), logs generated by the operating systems 110a-110c, n-tuple attributes of packets processed by the network appliances 108, etc. Therefore, the runtime data 118 is representative of any type of data generated by the system 100 in operation. Examples of runtime data 118 include, but are not limited to, outputted data, processor use metrics, disk use metrics, database access metrics, logs, network hops, queues, code monitoring, metrics, events, exceptions, profiling data, configuration data, trace data. errors, warnings, informational messages, usage, memory consumption, response times, request counts, user interactions, state changes, system alerts, and the like.

The runtime manager 116 may collect the runtime data 118 from the components of the system 100 based at least in part on the configuration 122. For example, the configuration 122 may specify, for a given entity in the system 100, types of data that can be collected, locations where the data can be accessed, credentials to access the data, and the like. For example, the configuration 122 may specify that user deposit accounts are managed at an example location in a first data store 126a of a first server 104. As another example, the configuration 122 may specify that an external payment processing system (e.g., one of the servers 104 managed by a third party) has various APIs for requesting data, returning state, etc. Embodiments are not limited in these contexts.

The model 124 is an artificial intelligence (AI) model that detects locations of errors in the system 100 based on the runtime data 118 and the workflow templates 120. The model 124 may be any type of AI model, such as a large language model (LLM), neural network, machine learning model, etc. The model 124 may be trained using training data. Examples of training data that may be used to train the model 124 include the runtime data 118, the configuration 122, and/or the workflow templates 120. For example, the model 124 may be trained to learn processing operation flows, learn the expected interactions between different components of the flows, learn the types of runtime data generated by a given phase of the flow, learn to identify errors, learn to determine the source of errors, and/or generate corrective actions to repair errors. Embodiments are not limited in these contexts.

Therefore, training the model 124 may include preprocessing the training data in the runtime data 118, workflow templates 120, and/or configuration 122. For example, the training data may be structured and cleaned to ensure consistency (e.g., removing noise, handling missing values, normalizing numerical features, etc.). Features may be derived from the runtime data 118 that are relevant to the workflow templates 120. Examples of relevant features may include execution times, resource usage patterns, error rates, specific error occurrences, etc. The runtime data 118 may further be mapped to the workflow templates 120, e.g., to identify which parts of the runtime data 118 correspond to specific stages or components in the workflow templates 120. Similarly, the runtime data 118 may be annotated based on the workflow templates 120, or vice versa. For example, training data in the runtime data 118 may be annotated to indicate where errors occurred and detailing the context in which errors occurred.

The preprocessed and annotated training dataset is then used to train the model 124. During this process, the model 124 is provided with input features derived from the runtime data 118 while using the corresponding labels from the workflow templates 120. The features may include features that represent both the system state at the time of the error and the corrective actions taken (if any) as labels. The training may further include, for each error in the training dataset, training the model to suggest possible corrective actions based on historical data. For example, the model 124 may be trained to classify errors and map the errors to predetermined corrective actions.

The trained model 124 may be used to identify errors and suggest corrective actions in real-time based on real-time runtime data 118. For example, the trained model 124 may determine that a server 104 has no available CPU or memory resources, that a data store 126a is offline, etc. The model 124 may further determine a corrective action, e.g., to migrate an application (or container or virtual machine) to another server 104, restart the data store 126a, etc.

In some embodiments, the runtime manager 116 may initiate performance of the corrective action generated by the model 124. For example, the runtime manager 116 may cause migration of the application, restarting the data store 126a, etc. In some embodiments, the runtime manager 116 may receive user approval prior to initiating the corrective action.

In some embodiments, the model 124 may process the runtime data 118 at periodic timing intervals, e.g., every 10 minutes, every hour, etc. In some embodiments, the model 124 may process the runtime data 118 based on user input. In some embodiments, the model 124 may be retrained at periodic time intervals to improve the accuracy of the model 124. Embodiments are not limited in these contexts.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 114 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 106 may include automatic teller machines (ATMs) utilized by the system 100 in serving users. In another example, the servers 104 and/or network appliances 108 represent payment clearinghouse or payment rail systems for processing payment transactions, and in another example, the servers 104 such as merchant systems or banking systems configured to interact with the user device 106 during transactions and also configured to interact with the enterprise system 100 in back-end transactions clearing processes.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user device 106) to serve users in their interactions to communicate and take action. In such embodiments, the user device 106 can be, as non-limiting examples, computing devices, kiosks, terminals, smart devices such as phones, and devices and tools at customer service counters and windows at POS locations.

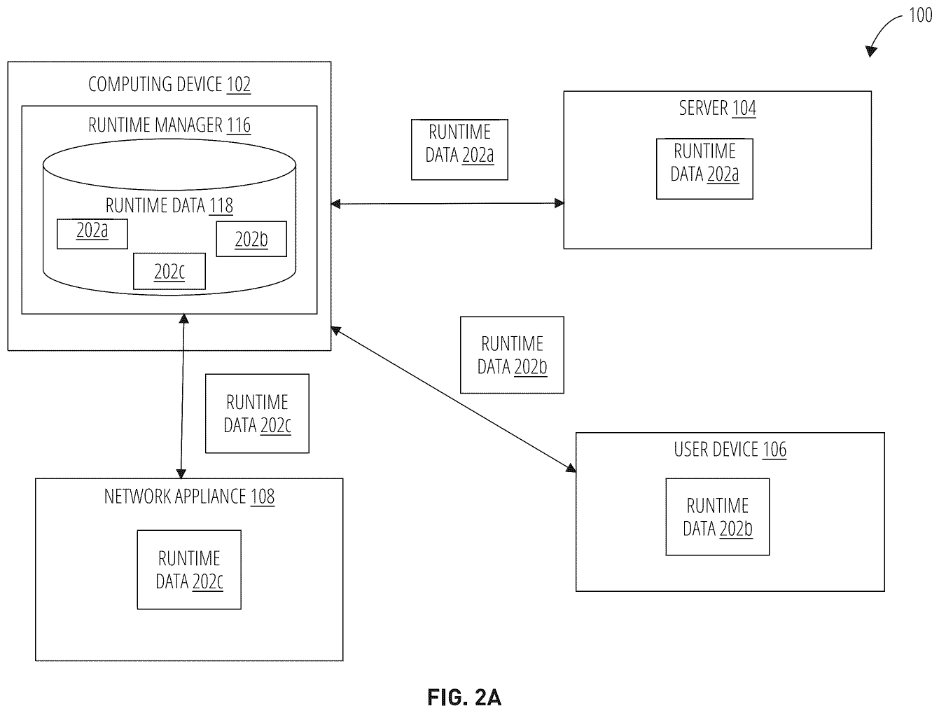

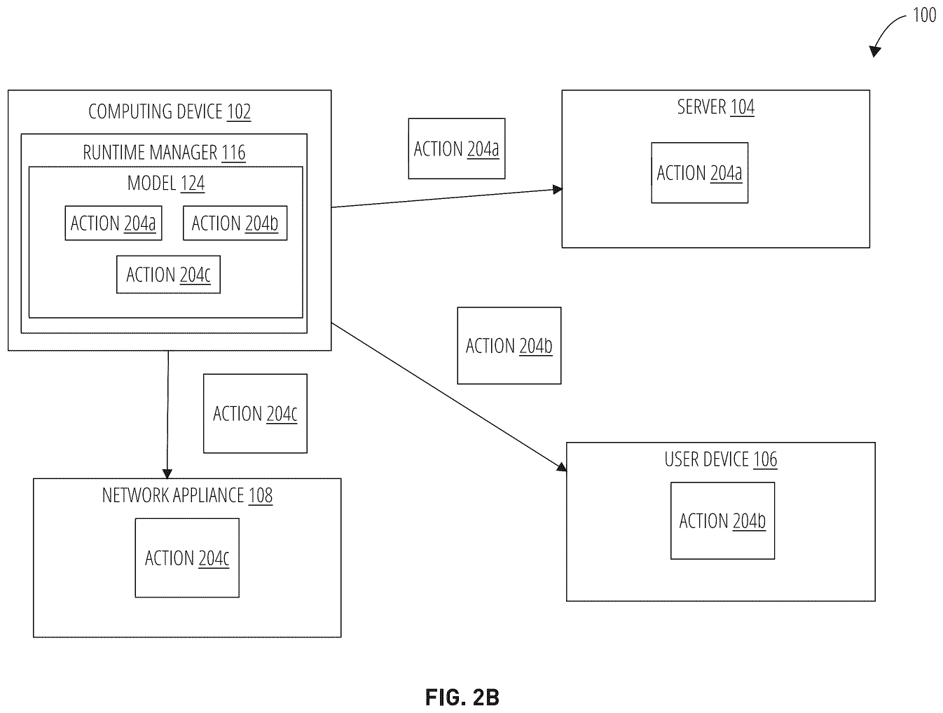

FIG. 2A is a schematic illustrating an example of data-driven detection of errors in data processing operations in the system 100, according to one embodiment.

As shown, the server 104, user device 106, and network appliance 108 of FIG. 1 may generate runtime data 202a-202c, respectively. The runtime data 202a-202c may describe any number and type of processing operations performed on the corresponding device (e.g., by the operating systems 110a-110c, the applications 112a-112c, the data stores 126a-126c, etc.).

For example, a user may initiate a monetary transfer to a friend using an application 112b on the user device 106. The runtime data 202a-202c may therefore reflect processing operations performed by the user device 106, server 104, and/or network appliance 108 during the processing flow associated with the monetary transfer. For example, the runtime data 202b may reflect the transfer initiated by the user via the user device 106, runtime data 202c may reflect the transfer of data associated with the requested transfer to the server 104, runtime data 202a may reflect processing of the data associated with the requested transfer by application 112a of server 104.

Once received, the runtime manager 116 may store the runtime data 202a-202c in the runtime data 118. The model 124 may then process the runtime data 202a-202c to detect one or more errors in the processing flow associated with the transfer (e.g., based on a corresponding template in the workflow templates 120).

FIG. 2B illustrates an embodiment where the model 124 generates one or more corrective actions 204a-204c based on the detected errors. The corrective actions 204a-204c may be any type of action. Examples of corrective actions include, but are not limited to, modifying configurations (e.g., of the servers 104, user devices 106, network appliances 108, network 114, operating systems 110a-110c, applications 112a-112c, data stores 126a-126c, etc.), installing software, executing code, modifying existing code, restarting hardware and/or software, etc.

For example, action 204a may cause server 104 to allocate more memory to application 112a, to correct slow transaction processing speeds using application 112a. As another example, action 204b may cause user device 106 to connect to a different communications interface (e.g., from cellular to Wi-Fi) to improve poor data transfer speeds. As yet another example, action 204c may cause network appliance 108 to update its routing tables to reduce the number of hops to transfer data from the user device 106 to the server 104.

The runtime manager 116 may then transmit the corrective actions 204a-204c (and/or indications thereof) to initiate the performance of the corrective actions on the respective device. Doing so may resolve any errors, e.g., slow processing times for the user-initiated transfer. Embodiments are not limited in these contexts.

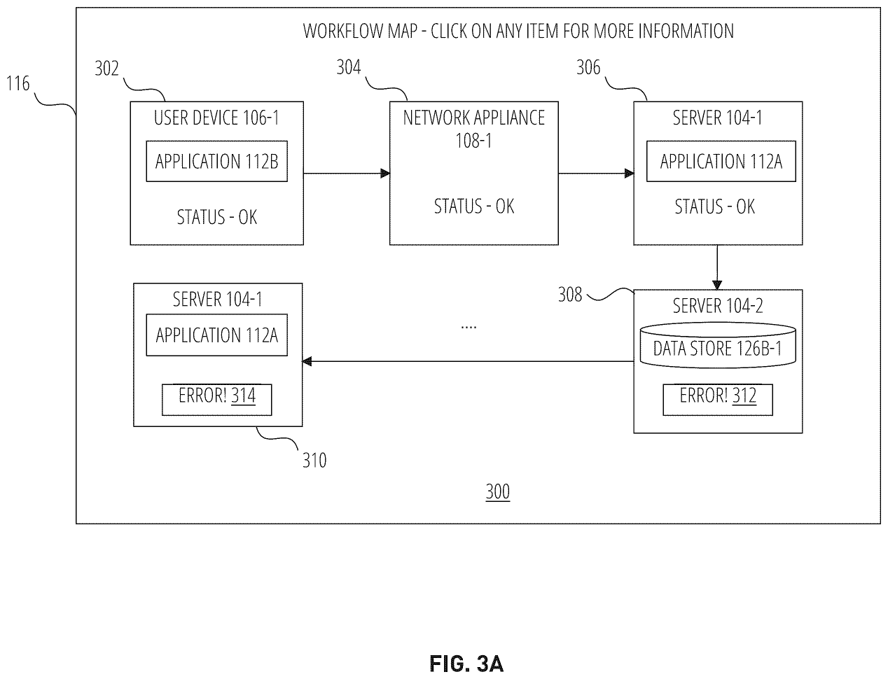

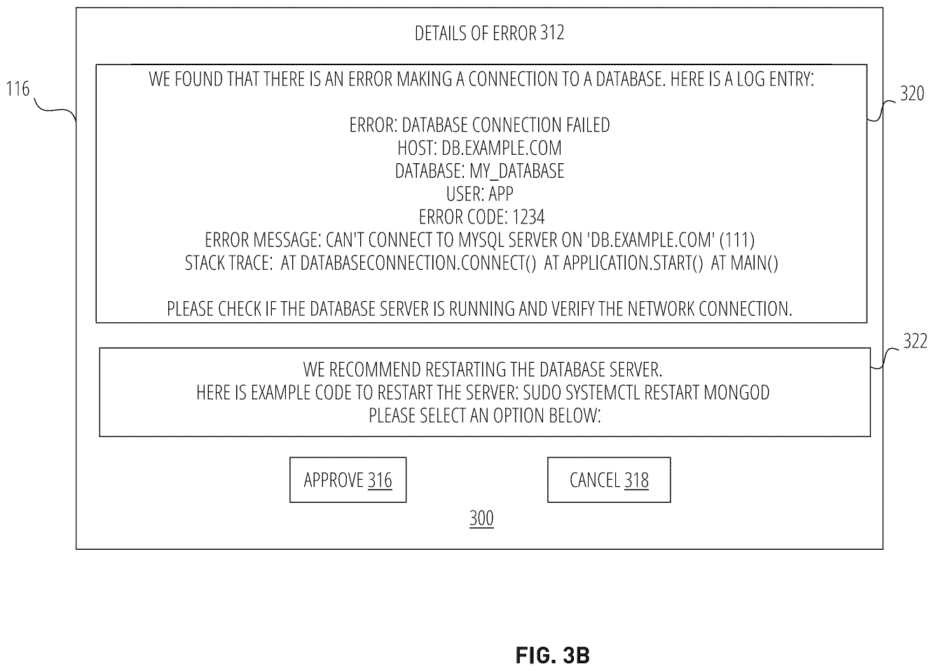

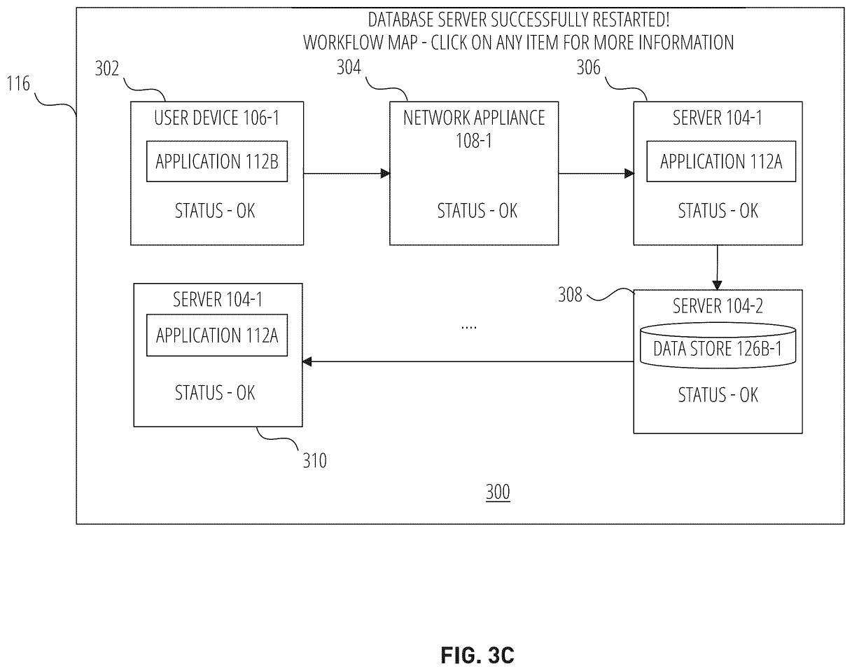

FIG. 3A illustrates a graphical user interface 300 of the runtime manager 116, according to one embodiment. The graphical user interface 300 may be generated by the runtime manager 116 and/or the model 124. More generally, the model 124 may process runtime data 118 as described herein to identify one or more errors in a processing operation associated with a template from the workflow templates 120. The graphical user interface 300 may therefore generally reflect the high-level workflow and any errors identified by the model 124.

As shown, the graphical user interface 300 includes blocks 302-310, which are graphical indications of various phases of the processing operation. Furthermore, each block 302-310 includes an indication of one or more components of the system 100 involved in the workflow and a respective status of the corresponding processing phase.

For example, as shown, block 302 of the workflow is associated with an example user device 106-1 executing application 112b. Block 304 of the workflow is associated with network appliance 108-1, which may reflect that the network appliance 108 receives data from the user device 106-1 and forwards the data to server 104-1 for processing by application 112a at block 306 of the workflow. At block 308 of the workflow, application 112a of server 104 may request data from a data store 126b-1 of server 104-2. At block 310 of the workflow, the server 104-1 may receive data from the data store 126b.

As shown, blocks 302-306 are associated with “OK” status, indicating no errors are occurring at these phases of the processing operation. However, as shown, blocks 308 and 310 are associated with errors represented by selectable element 312 and selectable element 314, respectively. Advantageously, a user may select the selectable element 312 or selectable element 314 to view additional information describing the errors.

FIG. 3B illustrates an embodiment where a user selects the selectable element 312 of FIG. 3A. As shown, the graphical user interface 300 of the runtime manager 116 includes an error description 320 generated by the model 124. The error description 320 generally indicates that an error connecting to data store 126b exists. The error description 320 may further include portions of an error log entry (e.g., a portion of runtime data 118).

As shown, the graphical user interface 300 further includes a recommendation 322 generated by the model 124. The recommendation 322 generally indicates that the database server for data store 126b needs to be restarted. The recommendation 322 further includes example code generated by the model 124 to restart the database server. A user may approve the restarting of the database server via selectable element 316. Similarly, the user may reject the restarting of the database server via selectable element 318.

FIG. 3C reflects an embodiment where the user initiated the restart of the database server via selectable element 316. As shown, the graphical user interface 300 has been updated to reflect the operational state of the processing operation (which may be the same processing operation or other instances of the same processing operation). Advantageously, the restart of the database server corrected the errors such that server 104-1 receives the data from data store 126b. Embodiments are not limited in these contexts.

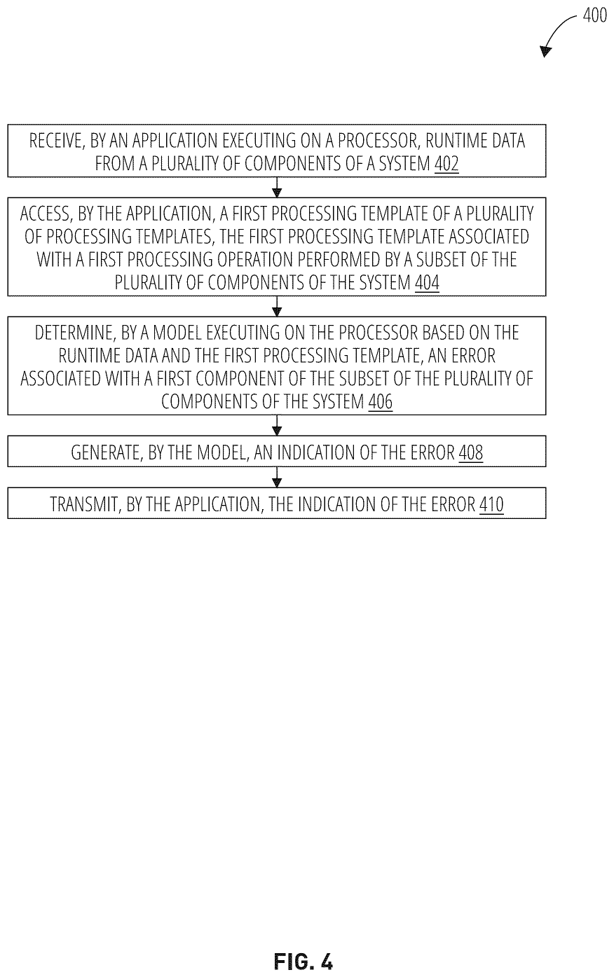

FIG. 4 illustrates an example logic flow 400 for data-driven detection of errors in data processing flows. Although the example logic flow 400 depicts a particular sequence of operations, the sequence may be altered without departing from the scope of the present disclosure. For example, some of the operations depicted may be performed in parallel or in a different sequence that does not materially affect the function of the logic flow 400. In other examples, different components of an example device or system that implements the logic flow 400 may perform functions at substantially the same time or in a specific sequence.

According to some examples, the logic flow 400 includes receiving, by an application executing on a processor, runtime data from a plurality of components of a system at block 402. For example, the runtime manager 116 illustrated in FIG. 1 may receive runtime data 118 from a plurality of components of a system such as the servers 104, user device 106, network appliances 108 (or any component thereof).

According to some examples, the logic flow 400 includes accessing, by the application, a first processing template of a plurality of processing templates, the first processing template associated with a first processing operation performed by a subset of the plurality of components of the system at block 404. For example, the runtime manager 116 may access a first processing template of a plurality of processing templates such as the workflow templates 120, the first processing template associated with a first processing operation performed by a subset of the plurality of components of the system 100. For example, the template from the workflow templates 120 may describe a workflow to send a message from a first user device 106 to a second user device 106.

According to some examples, the logic flow 400 includes determining, by a model executing on the processor based on the runtime data and the first processing template, an error associated with a first component of the subset of the plurality of components of the system at block 406. For example, the model 124 illustrated in FIG. 1 may determine, based on the runtime data and the first processing template, an error associated with a first component of the subset of the plurality of components of the system 100. For example, the model 124 may determine that a first network appliance 108 has processed packets that are below a packet processing threshold. As such, the model 124 may determine the error exists in the first network appliance 108.

According to some examples, the logic flow 400 includes generating, by the model, an indication of the error at block 408. For example, the model 124 illustrated in FIG. 1 may generate an indication of the error, e.g., a textual description of the error of the network appliance 108, the graphical user interface 300, etc.

According to some examples, the logic flow 400 includes transmitting, by the application, the indication of the error at block 410. For example, the runtime manager 116 illustrated in FIG. 1 may transmit the indication of the error generated by the model 124 at block 408 to a recipient user device 106. Doing so may allow the user to access the graphical user interface 300 to troubleshoot and repair the error with the first network appliance 108. Embodiments are not limited in these contexts.

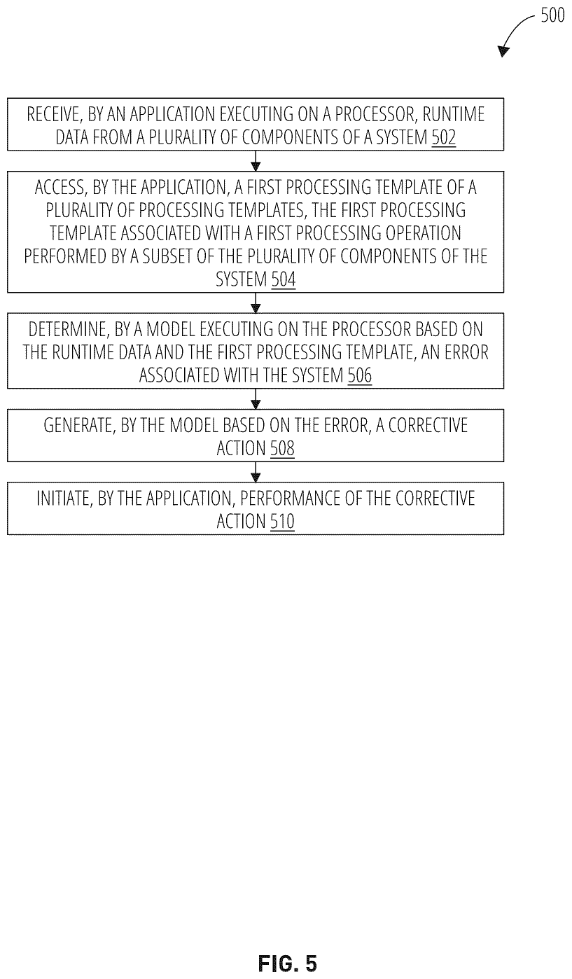

FIG. 5 illustrates an example logic flow 500 for data-driven detection of errors in data processing flows. Although the example logic flow 500 depicts a particular sequence of operations, the sequence may be altered without departing from the scope of the present disclosure. For example, some of the operations depicted may be performed in parallel or in a different sequence that does not materially affect the function of the logic flow 500. In other examples, different components of an example device or system that implements the logic flow 500 may perform functions at substantially the same time or in a specific sequence.

According to some examples, the logic flow 500 includes receiving, by an application executing on a processor, runtime data from a plurality of components of a system at block 502. For example, the runtime manager 116 illustrated in FIG. 1 may receive runtime data from a plurality of components of a system such as system 100.

According to some examples, the logic flow 500 includes accessing, by the application, a first processing template of a plurality of processing templates, the first processing template associated with a first processing operation performed by a subset of the plurality of components of the system at block 504. For example, the runtime manager 116 may access a first processing template of a plurality of processing templates, the first processing template associated with a first processing operation performed by a subset of the plurality of components of the system. For example, the first processing template may be a template from the workflow templates 120 for processing payment for a purchase.

According to some examples, the logic flow 500 includes determining, by a model executing on the processor based on the telemetry data and the first processing template, an error associated with the system at block 506. For example, the model 124 illustrated in FIG. 1 may determine, based on the runtime data 118 and the first processing template from the workflow templates 120, an error associated with the system 100. For example, the model 124 may determine, based on a CPU scheduling component of an operating system 110a, that server 104 lacks sufficient CPU resources to process the payment using application 112a.

According to some examples, the logic flow 500 includes generating, by the model based on the error, a corrective action at block 508. For example, the model 124 may generate, based on the error, a corrective action. For example, the model 124 may determine to migrate other applications or services from the server 104 to another location, thereby freeing CPU resources of the server 104 to process the payment using application 112a.

According to some examples, the logic flow 500 includes initiating, by the application, performance of the corrective action at block 510. For example, the runtime manager 116 may initiate performance of the corrective action, e.g., by causing migration of the other applications and/or services from the server 104 to free CPU resources. Doing so may allow the application 112a to at least partially process the payment. Embodiments are not limited in these contexts.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subject matter of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG, or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models, and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

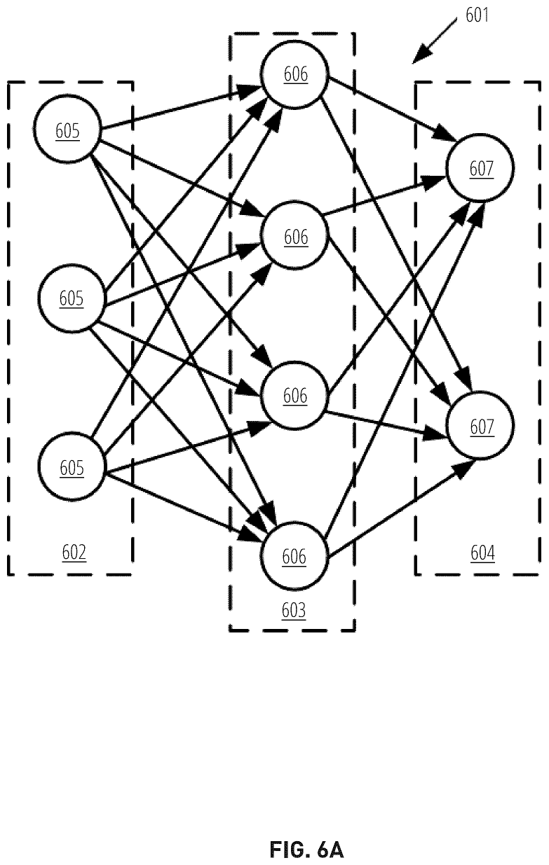

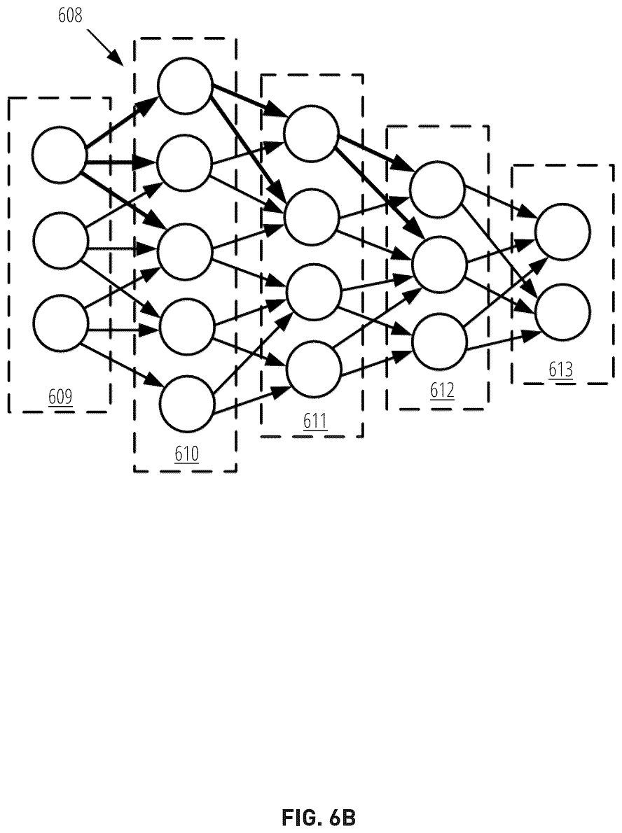

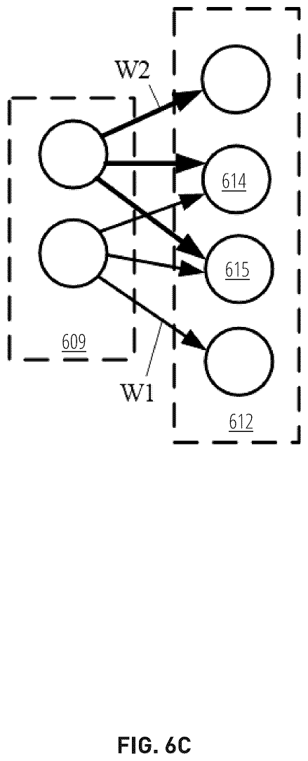

An artificial neural network (ANN), also known as a feedforward network, may be utilized, e.g., an acyclic graph with nodes arranged in layers. A feedforward network (see, e.g., feedforward network 601 referenced in FIG. 6A) may include a topography with a hidden layer 603 between an input layer 602 and an output layer 604. The input layer 602, having nodes commonly referenced in FIG. 6A as input nodes 605 for convenience, communicates input data, variables, matrices, or the like to the hidden layer 603, having nodes 606. The hidden layer 603 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 605 of the input layer, which then communicates the data to the hidden layer 603. The hidden layer 603 may be configured to determine the state of the nodes in the respective layers and assign weight coefficients or parameters of the nodes based on the edges separating each of the layers, e.g., an activation function implemented between the input data communicated from the input layer 602 and the output data communicated to the nodes 607 of the output layer 604. It should be appreciated that the form of the output from the neural network may generally depend on the type of model represented by the algorithm. Although the feedforward network 601 of FIG. 6A expressly includes a single hidden layer 603, other embodiments of feedforward networks within the scope of the descriptions can include any number of hidden layers. The hidden layers are intermediate the input and output layers and are generally where all or most of the computation is done. In some embodiments, the model 124 includes one or more feedforward networks 601.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model. In some embodiments, the model 124 includes one or more CNNs.

An exemplary convolutional neural network CNN is depicted and referenced as 608 in FIG. 6B. As in the basic feedforward network 601 of FIG. 6A, the illustrated example of FIG. 6B has an input layer 609 and an output layer 613. However where a single hidden layer 603 is represented in FIG. 6A, multiple consecutive hidden layers 610, 611, and 612 are represented in FIG. 6B. The edge neurons represented by white-filled arrows highlight that hidden layer nodes can be connected locally, such that not all nodes of succeeding layers are connected by neurons. In some embodiments, the model 124 includes one or more convolutional neural networks 608.

FIG. 6C, representing a portion of the convolutional neural network 608 of FIG. 6B, specifically portions of the input layer 609 and the first hidden layer 610, illustrates that connections can be weighted. In the illustrated example, labels W1 and W2 refer to respective assigned weights for the referenced connections. Two hidden nodes 614 and 615 share the same set of weights W1 and W2 when connecting to two local patches.

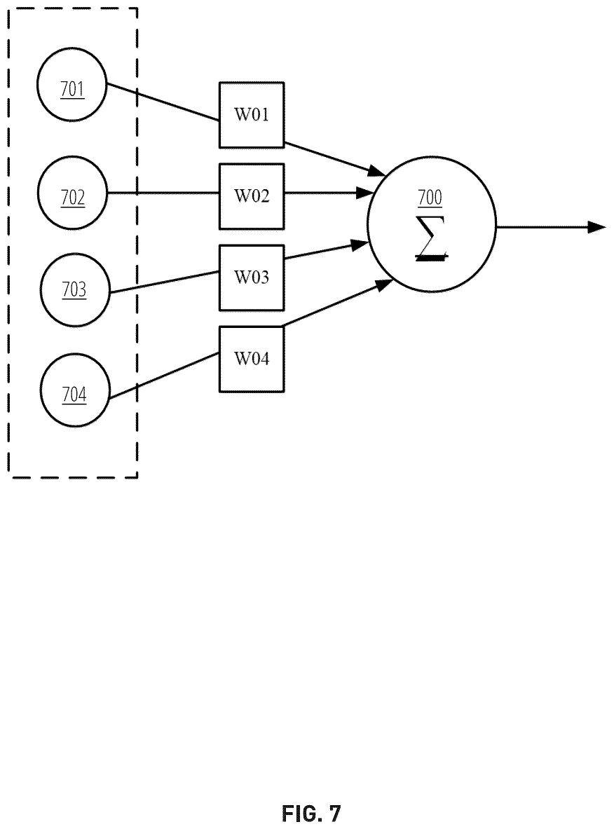

Weight defines the impact a node in any given layer has on computations by a connected node in the next layer. FIG. 7 represents a particular node 700 in a hidden layer. The node 700 is connected to several nodes in the previous layer representing inputs to the node 700. The input nodes 701, 702, 703 and 704 are each assigned a respective weight W01, W02, W03, and W04 in the computation at the node 700, which in this example is a weighted sum. In some embodiments, the model 124 includes one or more nodes such as nodes 700 and respective weights that are learned during training of the model 124.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

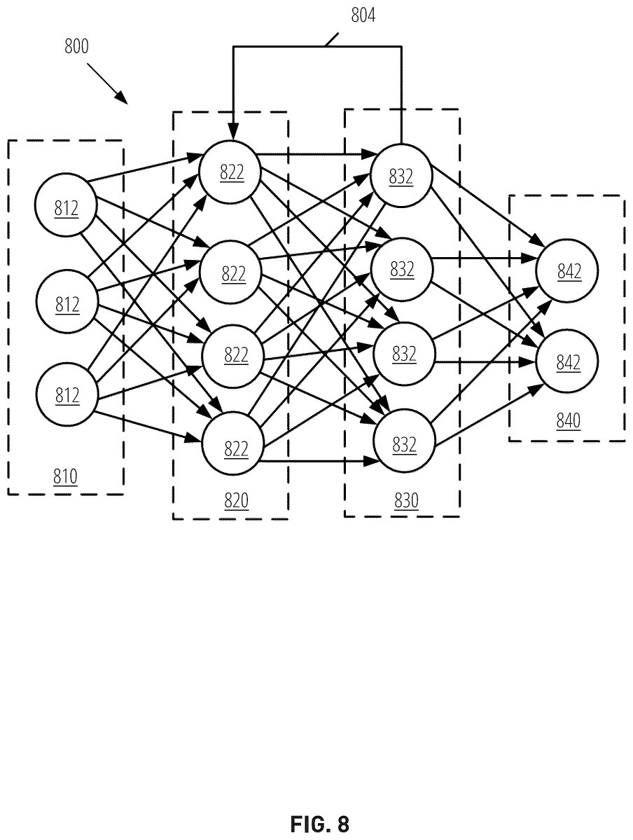

An example for a Recurrent Neural Network (RNN) is referenced as 800 in FIG. 8. In some embodiments, the model 124 includes one or more recurrent neural networks 800. As in the basic feedforward network 601 of FIG. 6A, the illustrated example of FIG. 8 has an input layer 810 (with nodes 812) and an output layer 840 (with nodes 842). However, where a single hidden layer 603 is represented in FIG. 6A, multiple consecutive hidden layers 820 and 830 are represented in FIG. 8 (with nodes 822 and nodes 832, respectively). As shown, the RNN 800 includes a feedback connector 804 configured to communicate parameter data from at least one node 832 from the second hidden layer 830 to at least one node 822 of the first hidden layer 820. It should be appreciated that two or more and up to all of the nodes of a subsequent layer may provide or communicate a parameter or other data to a previous layer of the RNN 800. Moreover and in some embodiments, the RNN 800 may include multiple feedback connectors 804 (e.g., connectors 804 suitable to communicatively couple pairs of nodes and/or feedback connectors 804 configured to provide communication between three or more nodes). Additionally or alternatively, the feedback connector 804 may communicatively couple two or more nodes having at least one hidden layer between them, i.e., nodes of nonsequential layers of the RNN 800.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

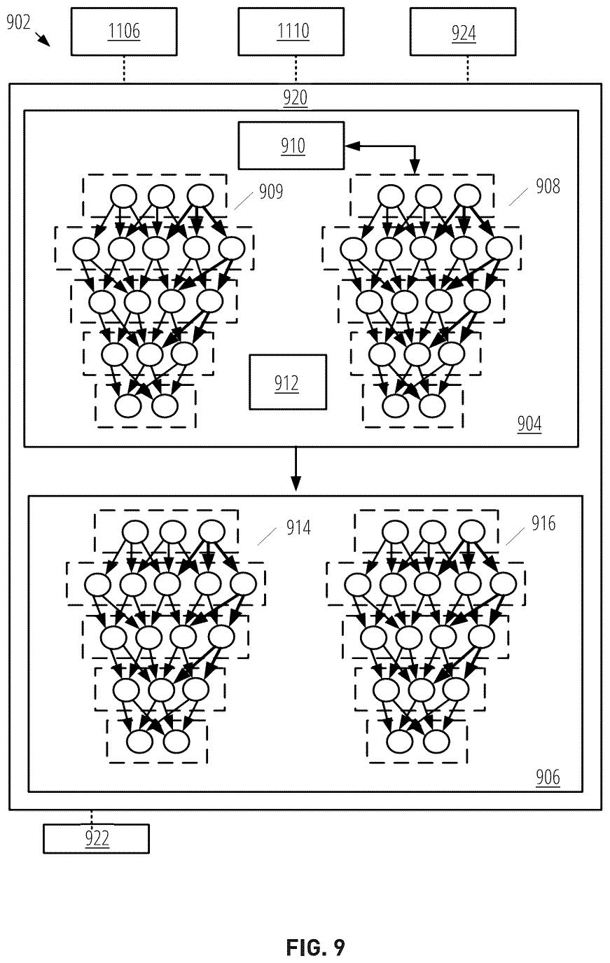

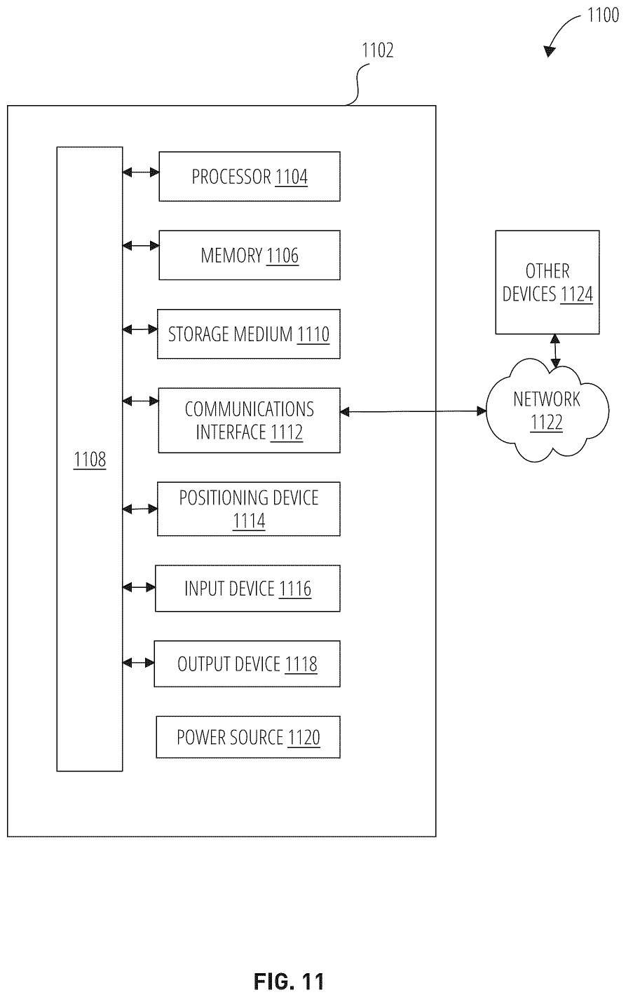

Referring now to FIG. 9 and some embodiments, an artificial intelligence (AI) program 902 may include a front-end network 904 and a back-end network 906. In some embodiments, the artificial intelligence program 902 is representative of the model 124. The artificial intelligence program 902 may be implemented on an AI processor 920, such as the processor 1104 of computer 1102 of FIG. 11, and/or a dedicated processing device. The instructions associated with the front-end network 904 (also referred to as an “algorithm” or “program”) and the back-end network (also referred to as an “algorithm” or “program”) 906 may be stored in an associated memory device and/or storage device of the system (e.g., storage device 1124 and/or memory 1106 of FIG. 11, etc.) communicatively coupled to the AI processor 920, as shown. Additionally or alternatively, the system may include one or more memory devices and/or storage devices (represented by memory 924 in FIG. 9) for processing use and/or including one or more instructions necessary for operation of the AI program 902. In some embodiments, the AI program 902 may include a deep neural network (e.g., a front-end network 904 configured to perform pre-processing, such as feature recognition, and a back-end network 906 configured to perform an operation on the data set communicated directly or indirectly to the back-end network 906). For instance, the front-end network 904 can include at least one CNN 908 communicatively coupled to send output data to the back-end network 906.

Additionally or alternatively, the front-end program 904 can include one or more AI algorithms 910, 912 (e.g., statistical models or machine learning programs such as decision tree learning, associate rule learning, recurrent artificial neural networks, support vector machines, and the like). In various embodiments, the front-end program 904 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 908 and/or AI algorithm 910 may be used for image recognition, input categorization, and/or support vector training. In some embodiments and within the front-end program 904, an output from an AI algorithm 910 may be communicated to a CNN 908 or 909, which processes the data before communicating an output from the CNN 908, 909 and/or the front-end program 904 to the back-end program 906. In various embodiments, the back-end network 906 may be configured to implement input and/or model classification, speech recognition, translation, and the like. For instance, the back-end network 906 may include one or more CNNs (e.g., CNN 914) or dense networks (e.g., dense networks 916), as described herein.

For instance, and in some embodiments of the AI program 902, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end program 904). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 902 may be trained using a semi-supervised learning process in which some but not all of the output data is known, e.g., a mix of labeled and unlabeled data having the same distribution.

In some embodiments, the AI program 902 may be accelerated via a machine learning framework 922 (e.g., hardware). The machine learning framework may include an index of basic operations, subroutines, and the like (primitives) typically implemented by AI and/or machine learning algorithms. Thus, the AI program 902 may be configured to utilize the primitives of the framework 922 to perform some or all of the calculations required by the AI program 902. Primitives suitable for inclusion in the machine learning framework 922 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

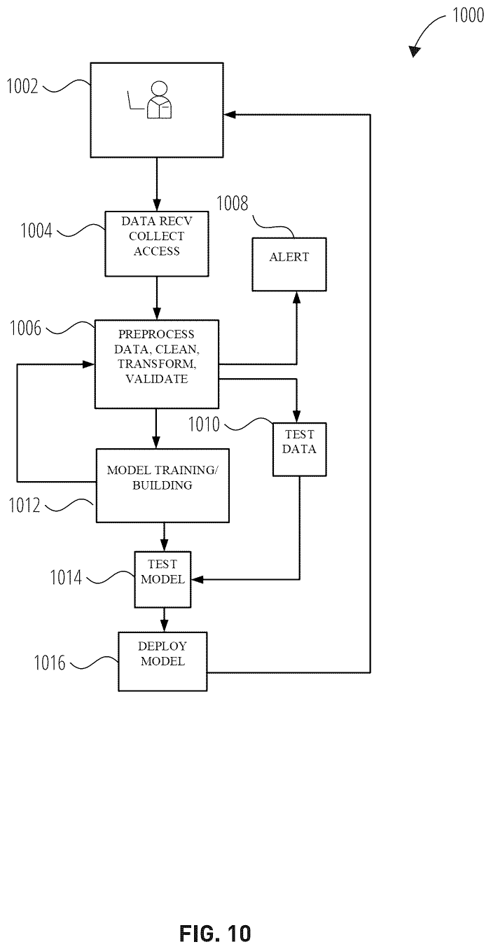

FIG. 10 is a flow chart representing a logic flow 1000, according to at least one embodiment, of model development and deployment by machine learning. The logic flow 1000 represents at least one example of a machine learning workflow in which operations are implemented in a machine-learning project. In some embodiments, the logic flow 1000 may be used to train the model 124.

In block 1002, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, block 1002 can represent a starting point. However, with regard to continuing or improving an ongoing machine learning workflow, block 1002 can represent an opportunity for further user input or oversight via a feedback loop.

In block 1004, data is received, collected, accessed, or otherwise acquired and entered as can be termed data ingestion. In block 1006, the data ingested in block 1004 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing block 1006 is updated with newly ingested data, an updated model will be generated. Block 1006 can include data validation, which focuses on confirming that the statistics of the ingested data are as expected, such as that data values are within expected numerical ranges, that data sets are within any expected or required categories, and that data comply with any needed distributions such as within those categories. Block 1006 can proceed to block 1008 to automatically alert the initiating user, other human or virtual agents, and/or other systems, if any anomalies are detected in the data, thereby pausing or terminating the process flow until corrective action is taken.

In block 1010, training test data such as a target variable value is inserted into an iterative training and testing loop. In block 1012, model training, a core step of the machine learning workflow, is implemented. A model architecture is trained in the iterative training and testing loop. For example, features in the training test data are used to train the model based on weights and iterative calculations in which the target variable may be incorrectly predicted in an early iteration as determined by comparison in block 1014, where the model is tested. Subsequent iterations of the model training, in block 1012, may be conducted with updated weights in the calculations.

When compliance and/or success in the model testing in block 1014 is achieved, process flow proceeds to block 1016, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

FIG. 11 illustrates an example computing system 1100 suitable for implementing various embodiments as described herein. As shown, the computing system 1100 comprises a computer 1102, which is representative of any type of physical and/or virtualized computing device. Examples of the computer 1102 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 1102 is representative of some or all of the components of the computing device 102, servers 104, user devices 106, network appliances 108, and/or network 114. More generally, the computing system 1100 is configured to implement all systems, methods, apparatuses, media, and embodiments disclosed herein.

As shown, the computer 1102 includes one or more processors 1104, one or more memories 1106, one or more non-transitory storage media 1110, one or more communications interfaces 1112, one or more positioning devices 1114, one or more input devices 1116, and one or more output devices 1118 communicably coupled via an interconnect 1108. A power source 1120, such as a power supply, battery, or any type of power source may provide power to the computer 1102.

The processor 1104 is representative of any type of processing circuit. For example, the processor 1104 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1106 is representative of any computer readable medium to store data, code, or other information. The memory 1106 may include volatile memory, such as volatile Random Access Memory (RAM) including a cache area for the temporary storage of data. The memory 1106 may also include non-volatile memory, which can be embedded and/or may be removable. The non-volatile memory can additionally or alternatively include an electrically erasable programmable read-only memory (EEPROM), flash memory or the like. The storage medium 1110 is representative of any type of computer readable medium to store data, code, or other information. Examples of storage media 1110 include solid state drives, hard drives, Redundant Array of Independent Disks (RAID) drives, memory pools, USB storage devices, and the like.

The memory 1106 and storage medium 1110 can store any number and type of computer-executable instructions executed by the processor 1104 to implement the functions of the computer 1102 described herein. For example, the memory 1106 may include such applications as a web browser application and/or a mobile P2P payment system client application. These applications also typically provide a graphical user interface (GUI) on a display that allows the user to communicate with the computer 1102, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 1106 and/or storage medium 1110 may be used to store data such as cached data, files for user accounts, user profiles, account balances, transaction histories, files downloaded or received from other devices, and any other data items.

The interconnect 1108 is representative of any type of circuitry to connect the components of the computer 1102. For example, the interconnect 1108 can include or represent, a system bus, a universal serial bus (USB) interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1104 to the memory 1106, individual electrical connections among the components, and electrical conductive traces on a motherboard common to some or all of the above-described components of the computer 1102. As discussed herein, the interconnect 1108 may operatively couple various components with one another, or in other words, electrically connects those components, either directly or indirectly - by way of intermediate component(s) with one another.

The one or more input devices 1116 are representative of any type of input device for receiving input, such as a keypad, keyboard, touchscreen, touchpad, microphone, camera, fingerprint sensor, mouse, joystick, other pointer device, button, soft key, and the like. The one or more output devices 1118 are representative of any type of device for outputting information, such as a monitor, speaker, haptic feedback module, printer, and the like.

The computer 1102 may use the communications interface 1112 to communicate with one or more other devices 1124 via a network 1122. The communications interface 1112 allows the computer 1102 to communicate with and conduct transactions with other devices and systems, such as the other devices 1124. The communications interface 1112 may be a wired and/or a wireless interface. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communications interface 1112, which can be or include a radio-frequency transceiver, a Bluetooth device, Wi-Fi device, a Near-Field Communication (NFC) device, and other wireless transceivers. In addition, a positioning device 1114 such as a Global Positioning System (GPS) device may be included for navigation and location-related data exchanges, ingoing and/or outgoing. Wi-Fi networks use radio technologies called IEEE 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 1112, e.g., using USB, Ethernet, and other physically connected modes of data transfer. The network 1122 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1102 is configured to use the communications interface 1112 as, for example, a network interface to communicate with one or more other devices on a network such as network 1122. In this regard, the computer 1102 utilizes the wireless communications interface 1112 as an antenna operatively coupled to a transmitter and a receiver (together a “transceiver”) included with the communications interface 1112. The communications interface 1112 is configured to provide signals to and receive signals from the transmitter and receiver, respectively. The signals may include signaling information in accordance with the air interface standard of the applicable cellular system of a wireless telephone network. In this regard, the computer 1102 may be configured to operate with one or more air interface standards, communication protocols, modulation types, and access types. By way of illustration, the computer 1102 may be configured to operate in accordance with any of a number of first, second, third, fourth, fifth-generation communication protocols and/or the like. For example, the as a smartphone, the computer 1102 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 1102 may also be configured to operate in accordance with non-cellular communication mechanisms, such as via a wireless local area network (WLAN) or other communication/data networks.

The communications interface 1112 may also include a payment network interface. The payment network interface may include software, such as encryption software, and hardware, such as a modem, for communicating information to and/or from one or more devices on a network. For example, the computer 1102 may be configured so that it can be used as a credit or debit card by, for example, wirelessly communicating account numbers or other authentication information to a terminal of the network. Such communication could be performed via transmission over a wireless communication protocol such as the NFC protocol.

The computer 1102 may be under the control of any suitable operating system (not pictured). Example operating systems include, but are not limited to, Linux® operating systems, UNIX®, Windows® operating systems, macOS®, iOS®, Android® and any other type of operating system.

The computer 1102 as illustrated diagrammatically represents at least one example of a possible implementation, where alternatives, additions, and modifications are possible for performing some or all of the described methods, operations, and functions. Although shown separately, in some embodiments, two or more computers 1102, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

1. A method, comprising:
receiving, by an application executing on a processor, runtime telemetry data comprising logs, exception events, and network packet n-tuple attributes from a plurality of components of a system that implements multi-stage processing workflows;
mapping, by the application, the runtime telemetry data to a first processing template of a plurality of processing templates, the first processing template associated with the multi-stage processing workflow for a first processing operation performed by a subset of the plurality of components of the system;
determining, by a model executing on the processor based on the mapped runtime telemetry data and the first processing template, an error associated with a first component of the subset of the plurality of components of the system, the model trained to: (i) determine error sources based on training logs, training exception events, and training network packet n-tuple attributes, and (ii) map errors to corrective actions;
generating, by the model, a machine-executable corrective action mapped to the determined error; and
initiating, by the application, performance of the machine-executable corrective action in the system.

2. The method of claim 1, further comprising:
generating, by the model, an indication of the error; and
transmitting, by the application, the indication of the error via a network.

3. The method of claim 1, further comprising:
generating, by the application, a graphical user interface comprising indications of the subset of the plurality of components of the system and an indication of the error.

4. The method of claim 3, wherein the indication of the error is displayed proximate to the indication of the first component.

5. The method of claim 1, wherein the plurality of components of the system comprise: (i) a plurality of computing systems, (ii) software executing on the plurality of computing systems, (iii) one or more communications networks, (iv) network appliances of the one or more communications networks, and (v) software executing on the network appliances.

6. The method of claim 5, wherein the runtime telemetry data further comprises: (i) data generated by the plurality of computing systems, (ii) data generated by the software executing on the plurality of computing systems, (iii) data generated by the one or more communications networks, (iv) the network packet n-tuple attributes generated by the network appliances of the one or more communications networks, and (v) data generated by the software executing on the network appliances.

7. The method of claim 1, further comprising:
processing, by the application, the runtime telemetry data for at least one of: analysis of an impact on the system, analysis of a change in the system, or analysis of the error.

8. A non-transitory computer-readable storage medium, the computer-readable storage medium including instructions that when executed by a processor, cause the processor to:
receive, by an application, runtime telemetry data comprising logs, exception events, and network packet n-tuple attributes from a plurality of components of a system that implements multi-stage processing workflows;
map, by the application, the runtime telemetry data to a first processing template of a plurality of processing templates, the first processing template associated with the multi-stage processing workflow for a first processing operation performed by a subset of the plurality of components of the system;
determine, by a model based on the mapped runtime telemetry data and the first processing template, an error associated with a first component of the subset of the plurality of components of the system, the model trained to: (i) determine error sources based on training logs, training exception events, and training network packet n-tuple attributes, and (ii) map errors to corrective actions;
generate, by the model, a machine-executable corrective action mapped to the determined error; and
initiate, by the application, performance of the machine-executable corrective action in the system.

9. The computer-readable storage medium of claim 8, wherein the instructions further cause the processor to:
generate, by the model, an indication of the error; and
transmit, by the application, the indication of the error via a network.

10. The computer-readable storage medium of claim 8, wherein the instructions further cause the processor to:
generate, by the application, a graphical user interface comprising indications of the subset of the plurality of components of the system and an indication of the error.

11. The computer-readable storage medium of claim 10, wherein the indication of the error is displayed proximate to the indication of the first component.

12. The computer-readable storage medium of claim 8, wherein the plurality of components of the system comprise: (i) a plurality of computing systems, (ii) software executing on the plurality of computing systems, (iii) one or more communications networks, (iv) network appliances of the one or more communications networks, and (v) software executing on the network appliances.

13. (canceled)

14. The computer-readable storage medium of claim 8, wherein the instructions further cause the processor to:
process, by the application, the runtime telemetry data for at least one of: analysis of an impact on the system, analysis of a change in the system, or analysis of the error.

15. An apparatus, comprising:
a processor; and
a memory storing instructions that, when executed by the processor, cause the processor to:
receive, by an application, runtime telemetry data comprising logs, exception events, and network packet n-tuple attributes from a plurality of components of a system that implements multi-stage processing workflows;
map, by the application, the runtime telemetry data to a first processing template of a plurality of processing templates, the first processing template associated with the multi-stage processing workflow for a first processing operation performed by a subset of the plurality of components of the system;
determine, by a model based on the mapped runtime telemetry data and the first processing template, an error associated with a first component of the subset of the plurality of components of the system, the model trained to: (i) determine error sources based on training logs, training exception events, and training network packet n-tuple attributes, and (ii) map errors to corrective actions;
generate, by the model based on the error, a machine-executable corrective action mapped to the determined error; and
initiate, by the application, performance of the machine-executable corrective action in the system.

16. The apparatus of claim 15, wherein the instructions further cause the processor to:
generate, by the model, an indication of the error; and
transmit, by the application, the indication of the error via a network.

17. The apparatus of claim 15, wherein the instructions further cause the processor to:
generate, by the application, a graphical user interface comprising indications of the subset of the plurality of components of the system and an indication of the error.

18. The apparatus of claim 15, wherein the plurality of components of the system comprise: (i) a plurality of computing systems, (ii) software executing on the plurality of computing systems, (iii) one or more communications networks, (iv) network appliances of the one or more communications networks, and (v) software executing on the network appliances.

19. (canceled)

20. The apparatus of claim 15, wherein the instructions further cause the processor to:
process, by the application, the runtime telemetry data for at least one of: analysis of an impact on the system, analysis of a change in the system, or analysis of the error.

21. The method of claim 1, further comprising:
receiving, by the application, additional runtime telemetry data from the plurality of components of the system;
determining, by the application, based on the processing template and the additional runtime telemetry data, that expected interactions with the first component are reflected in the additional runtime telemetry data;
verifying, by the application, resolution of the error based on the determination that the expected interactions with the first component are reflected in the additional runtime telemetry data.

22. The method of claim 1, wherein the corrective action comprises one or more of: restarting a database, reallocating memory to an application, migrating the application to another server, updating a routing table of a network appliance that generated the network packet n-tuple attributes, or causing a client device to switch from using a first network interface to using a second network interface.
